(19) United States
(12) Patent Application Publication
(10) Pub. No.: US 2017/0026729 A1
(43) Pub. Date: Jan. 26, 2017

(54) MICROPHONE WITH PRESSURE SENSOR

(71) Applicant: Knowles Electronics, LLC, Itasca, IL (US)

(72) Inventors: John J. Albers, Chicago, IL (US); Norman Dennis Talag, Woodridge, IL (US); Kurt B. Friel, Sycamore, IL (US)

(73) Assignee: Knowles Electronics, LLC, Itasca, IL (US)

(21) Appl. No.: 15/216,627

(22) Filed: Jul. 21, 2016

Related U.S. Application Data
(60) Provisional application No. 62/196,070, filed on Jul. 23, 2015.

(51) Int. Cl. H04R 1/04; G01L 9/00; H04R 29/00

(52) U.S. Cl. CPC H04R 1/04; H04R 29/004; G01L 9/0005; H04R 2201/003

(57) ABSTRACT

A microphone includes a base, a MEMS device, and an integrated circuit. The MEMS device includes a diaphragm and a back plate. The MEMS device is connected to the integrated circuit. The microphone also includes a pressure sensor. A lid enclosed the MEMS device and the integrated circuit.

### CROSS-REFERENCE TO RELATED APPLICATIONS

This application claims the benefit of and priority to U.S. Provisional Patent Application No. 62/196,070, filed Jul. 23, 2015, the entire contents of which are incorporated herein by reference.

### TECHNICAL FIELD

This application relates to microphones and, more specifically, to microphones that include sensors.

### BACKGROUND OF THE INVENTION

Different types of acoustic devices have been used through the years. One type of device is a microphone. In a microelectromechanical system (MEMS) microphone, a MEMS die includes a diagram and a back plate. The MEMS die is supported by a substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential of the back plate, which creates an electrical signal. Microphones are deployed in various types of devices such as personal computers or cellular phones.

In many different situations, it is desirable to have sensors deployed with, within, or at the microphone. For example, in cellular phones, lap tops, or tablets it is desired to measure pressure for various reasons or applications. Sensor chip-like elements have been deployed in microphones to measure the pressure. However, these sensors are bulky and take up space. Because of their size, they increase the microphone size, and this is not desirable in many situations. In many situations, the size of the microphone is fixed, and so placing a sensor in the microphone may be impossible to do within the size constraints.

The problems of previous approaches have resulted in some user dissatisfaction with these previous approaches.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 comprises a perspective diagram of a microphone with a pressure sensor according to various embodiments of the present invention;

FIG. 2 comprises side cut-away view of the microphone of FIG. 1 according to various embodiments of the present invention;

FIG. 3 comprises perspective cut-away view of a microphone with pressure sensor according to various embodiments of the present invention;

FIG. 4 comprises perspective, side cut-away view of a microphone with pressure sensor according to various embodiments of the present invention;

FIG. 5 comprises a side cutaway view of a sensor according to various embodiments of the present invention.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

The present approaches provide a pressure sensor that is in, on, integrated with, and/or at the lid of a micro electro mechanical system (MEMS) microphone. In disposing the sensor on the lid, significant space savings are achieved. Consequently, a small-sized microphone is provided and achieved allowing the microphone deployed in applications where miniaturization is required or advantageous.

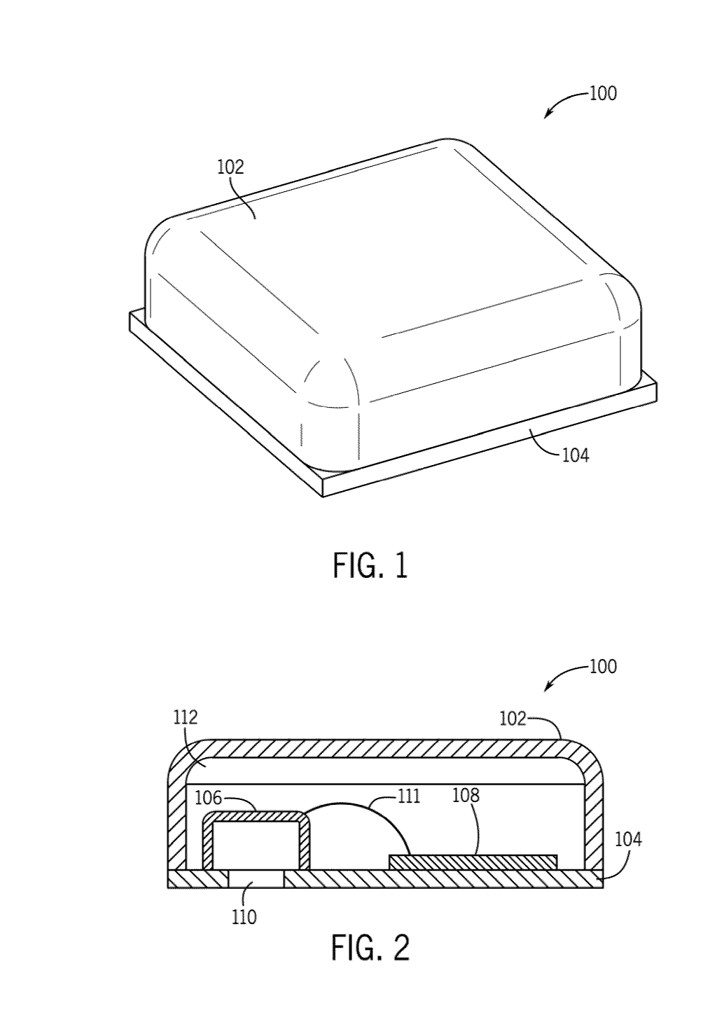

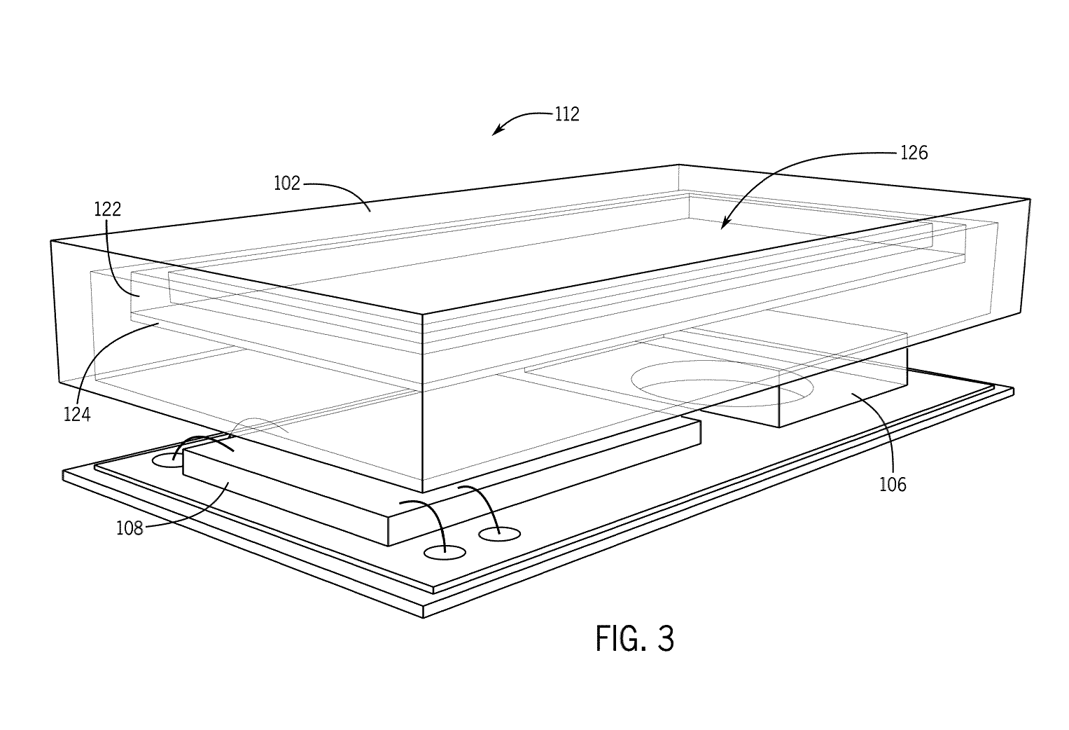

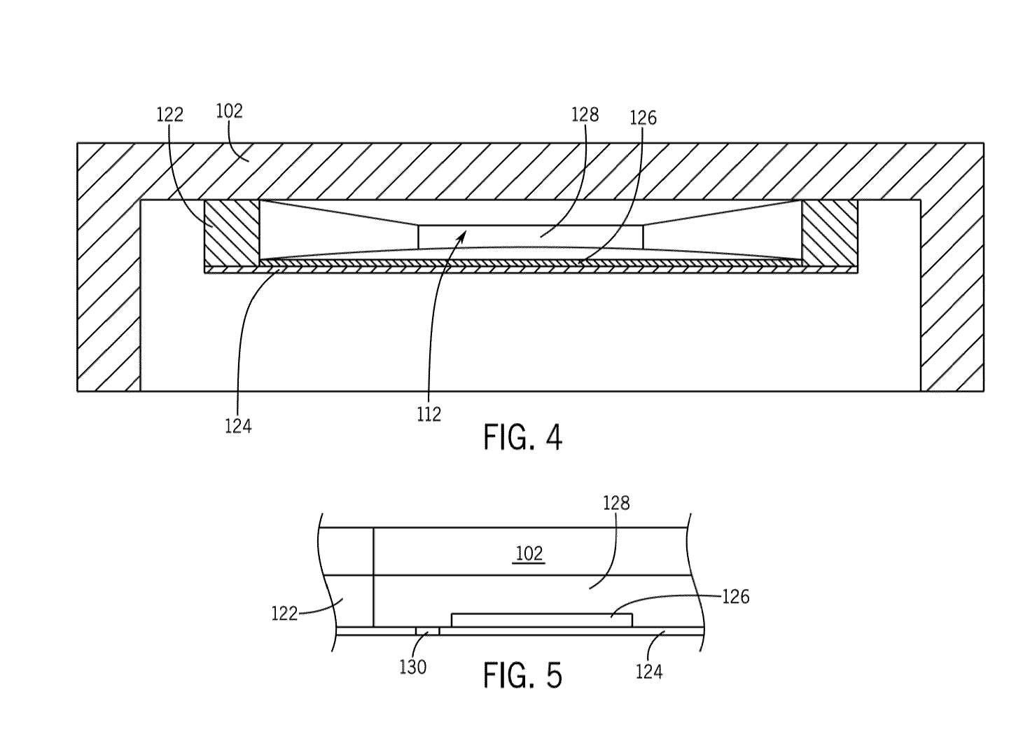

Referring now to FIG. 1, FIG. 2, FIG. 3, FIG. 4, and FIG. 5, one example of a microphone 100 that includes a pressure sensor that is embedded in, at, on, or integrated into the lid of the microphone 100 is described. The microphone 100 includes a lid 102, a base 104, a micro electro mechanical system (MEMS) device 106 (including a diaphragm and a back plate); and an integrated circuit 108.

It will be appreciated that the lid 102 in this example is a one-piece can type device. Alternatively, the lid 102 may have walls with a flat cover over the walls. In any case, the lid 102 encloses the MEMS device 106 and the integrated circuit 108. A port 110 extends through the base 104. Sound enters through the port 104, moves the diaphragm of the MEMS device 106, and electrical signal is created and this is transmitted by wires 111 to the integrated circuit 108.

The lid has a pressure sensor 112 coupled to the lid. The pressure sensor structure 112 is opposite the integrated circuit 108. The pressure sensor 112 includes a standoff 122, and a tape 124 (e.g., polyimide tape or any other flexible membrane element or other flexible element), and a metal electrode 126.

As mentioned, the tape 124 may be a flexible tape such as a polyimide. Other examples are possible. The standoff 122 is any structure configured to hold the tape 124. Together, the tape 124 and the standoff define a pocket of air 128 between this structure and the lid 102. A hole or opening 130 extends through the tape 124 allowing the low frequency roll of frequency of the response curve of the microphone to be set by varying the size of the hole 130.

The integrated circuit 108 is coupled to the pressure sensor 112 via leads 114. Pressure changes cause the tape 124 to move to different positions. This causes the potential with the metal electrode 126 to vary depending upon the amount of movement and the position of the movable element 124. The integrated circuit 108 senses the voltage signal thereby created and converts this signal into a capacitance representing the sensed pressure. As the pressure changes, the capacitance as measured between the metal can 102 and the metal electrode 126 changes and the change in (delta) capacitance represents the change in pressure. The conversion of capacitance into a corresponding pressure may be made, for example, using a look-up table where capacitance is an index value with each index value having a corresponding pressure.

In one example, a small amount of adhesive is deposited near the perimeter of the top of the lid. The polyimide tape with the metal electrode (and the very small hole 130) is placed on the adhesive. This creates the pocket of air 128 between the polyimide tape and the lid (can). As the pressure in the back volume changes, the polyimide layer 124 deforms. This turns the top side of the can and the polyimide layer (with electrode) 124 into a pressure sensor. Low frequency roll-off can be set by the size of the hole 130.

In one example of the operation of the examples of FIGS. 1-5, the integrated circuit 108 senses the change in capacitance of the capacitor created by the tape 124, electrode 126, and standoff 122. The integrated circuit 108 sensed change in capacitance and this change is representative of sensed pressure changes. The integrated circuit 108 measures this pressure, converts it into digital form, and may send this digital sensed pressure to an external electronics device. The integrated circuit 108 may couple to traces on the base and the traces may couple to external pads, and the external pads may couple to a consumer electronics device may be incorporated into a cellular phone, tablet, personal computer, or laptop to mention a few examples. In other implementations, the sensor can be a separate sensor, e.g., a silicon based sensor, which is attached to the base or on the lid. In these implementations, the sensor can be connected to the integrated circuit. In other implementations, the sensor can be integrated into the integrated circuit.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A microphone comprising:
a base;
a micro electro mechanical system (MEMS) device including a diaphragm and a back plate;
an integrated circuit connected to the MEMS device;
a pressure sensor; and
a lid, wherein the base and the lid enclose the MEMS device and the integrated circuit.

2. The microphone of claim 1, wherein the pressure sensor is coupled to the lid.

3. The microphone of claim 2, wherein the MEMS device is disposed on the base.

4. The microphone of claim 3, wherein the integrated circuit is disposed on the base.

5. The microphone of claim 4, wherein the base comprises a port that extends through the port, wherein the MEMS device covers the port to create a front volume.

6. The microphone of claim 1, wherein the pressure sensor comprises a standoff, a flexible element, and an electrode, wherein the flexible element and the standoff define an air pocket.

7. The microphone of claim 6, wherein the flexible element is tape.

8. The microphone of claim 7, wherein the tape comprises a polymide tape.

9. The microphone of claim 6, wherein the air pocket is formed between the standoff and the lid.

10. The microphone of claim 9, wherein the flexible element comprises an opening.

11. The microphone of claim 6, wherein the integrated circuit is configured to sense a change in capacitance from the flexible element, the electrode, and the standoff.

12. The microphone of claim 11, wherein the integrated circuit is configured to provide a value of pressure based upon the change in capacitance via an external pad.

13. The microphone of claim 12, wherein the integrated circuit is configured to convert the change in capacitance to the value of pressure based upon a look-up table.

14. A microphone comprising:
a base;
a micro electro mechanical system (MEMS) device including a diaphragm and a back plate;
an integrated circuit connected to the MEMS device;
a pressure sensor;
an external pad connected to the integrated circuit; and
a lid, wherein the base and the lid enclose the MEMS device and the integrated circuit.

15. The microphone of claim 14, wherein the base comprises a port that extends through the port, wherein the MEMS device covers the port to create a front volume.

16. The microphone of claim 14, wherein the pressure sensor comprises a standoff, a flexible element, and an electrode, wherein the flexible element and the standoff define an air pocket.

17. The microphone of claim 16, wherein the air pocket is formed between the standoff and the lid.

18. The microphone of claim 16, wherein the flexible element comprises an opening.

19. The microphone of claim 16, wherein the integrated circuit is configured to sense a change in capacitance from the flexible element, the electrode, and the standoff.

20. The microphone of claim 19, wherein the integrated circuit is configured to provide a value of pressure based upon the change in capacitance via the external pad.
